(19) United States
(12) Patent Application Publication
(10) Pub. No.: US 2017/0103411 A1
(43) Pub. Date: Apr. 13, 2017

(54) SYSTEM AND METHOD FOR SELECTIVE PAYMENT TERMS

(71) Applicant: LOADPAY LLC, New Plymouth, ID (US)

(72) Inventor: Scott W. Moscrip, New Plymouth, ID (US)

(21) Appl. No.: 15/288,905

(22) Filed: Oct. 7, 2016

Related U.S. Application Data
(60) Provisional application No. 62/239,194, filed on Oct. 8, 2015.

(51) Int. Cl. G06Q 30/02; G06N 99/00; G06Q 20/28

(52) U.S. Cl. CPC G06Q 30/0235; G06Q 20/28; G06N 99/005

(57) ABSTRACT

Systems and methods for a payment system may include: receiving, from a first party, a predetermined payment date and amount for goods or services provided by a second party; publishing, by a processor, the predetermined payment date and amount for viewing by the second party; calculating, by the processor, at least one reduced payment amount option for at least one pre-payment date, the pre-payment date in advance of the predetermined payment date calculated based at least on a discounting table; publishing, by the processor, one reduced payment amount; receiving, by the processor, a selection of one of the reduced payment amount options from a second party, wherein the selection comprises a selected reduced payment amount and one of the at least one pre-payment date; and facilitating payment from the first party to the second party according to the selected payment amount and date.

### CROSS-REFERENCE TO RELATED APPLICATIONS

This application claims priority to U.S. Provisional Patent Application No. 62/239,194, filed on 8 Oct. 2015, and entitled SYSTEM AND METHOD FOR SELECTIVE PAYMENT TERMS, which application is incorporated herein in its entirety by this reference.

### TECHNICAL FIELD

The present disclosure relates generally to payment systems and methods, and relates more particularly to payment systems and methods that facilitate selective payments terms between parties.

### BACKGROUND

The scenario of a first party making a payment for goods and services rendered by a second party has been going on for thousands of years. Often times, the payment for the goods or services is received after the goods or services have been delivered and/or provided. It is not uncommon for the paying party to delay the payment for any number of reasons, such as in situations where the paying party has large buying power or is in some other way leveraged as compared to the party that provides the goods or services. The paying party may delay payment a set amount of time (e.g., thirty days, sixty days, or ninety days) because any number of situations permit them to. The parties providing the goods or services may not be able to wait the delayed period to receive payment for any of a variety of reasons. Opportunities exist for meeting the needs and demands of the parties involved in various types of transactions involving goods or services.

### SUMMARY

A method for a payment system is described. The method may include: receiving, by a first party, a predetermined payment date and a predetermined payment amount for goods or services provided by a second party; publishing, by a processor, the predetermined payment date and predetermined amount for viewing by the second party; calculating, by the processor, at least one reduced payment amount option for at least one pre-payment date, the pre-payment date in advance of the predetermined payment date, the at least one reduced payment amount option calculated based at least on a discounting table; publishing, by the processor, the at least one reduced payment amount for viewing; receiving, by the processor, a selection of one of the at least one reduced payment amount options from a second party, wherein the selection comprises a selected reduced payment amount and one of the at least one pre-payment date; and facilitating payment from the first party to the second party according to the selected payment amount and payment date.

An apparatus for a payment system is described. The apparatus may include: a process, memory in electronic communication with the processor, instructions stored in the memory to: receive, from a first party, a predetermined payment date and a predetermined payment amount for goods or services provided by a second party; publish, by a processor, the predetermined payment date and predetermined amount for viewing by the second party; calculate, by the processor, at least one reduced payment amount option for at least one pre-payment date, the pre-payment date in advance of the predetermined payment date, the at least one reduced payment amount option calculated based at least on a discounting table; publish, by the processor, the at least one reduced payment amount for viewing; receive, by the processor, a selection of one of the at least one reduced payment amount options from a second party, wherein the selection comprises a selected reduced payment amount and one of the at least one pre-payment date; and facilitate payment from the first party to the second party according to the selected payment amount and payment date.

A non-transitory computer readable medium for a payment system is described. The non-transitory computer readable medium may include instructions to: receive, from a first party, a predetermined payment date and a predetermined payment amount for goods or services provided by a second party; publish, by a processor, the predetermined payment date and predetermined amount for viewing by the second party; calculate, by the processor, at least one reduced payment amount option for at least one pre-payment date, the pre-payment date in advance of the predetermined payment date, the at least one reduced payment amount option calculated based at least on a discounting table; publish, by the processor, the at least one reduced payment amount for viewing; receive, by the processor, a selection of one of the at least one reduced payment amount options from a second party, wherein the selection comprises a selected reduced payment amount and one of the at least one pre-payment date; and facilitate payment from the first party to the second party according to the selected payment amount and payment date.

In some examples of the method, apparatus, and non-transitory computer readable medium described above may further include processes, features, means, or instructions for calculating at least one reduced payment amount option by a computer learning algorithm, where calculating by the computer learning algorithm includes of at least one from the group comprising: decision trees, neural networks, Bayesian networks, associated rule learning, inductive logic, and clustering.

In some examples of the method, apparatus, and non-transitory computer readable medium described above may further include processes, features, means, or instructions for delivering, by a wireless communication, the selected reduced payment option to the first party; and receiving, by the processor, confirmation from the first party that the selected payment amount and payment date is acceptable prior to facilitating payment.

In some examples of the method, apparatus, and non-transitory computer readable medium described above may further include processes, features, means, or instructions for receiving electronic payment information associated with the selected payment amount; and sending the received electronic payment information to a financial institution associated with the second party.

In some embodiments, published predetermined payment date and predetermined payment amount and the at least one reduced payment amounts are available via a mobile computing device. In some embodiments, the discounting table includes decreasing percentages of the set payment amount, based at least in part on the calculating.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 is a block diagram of an example of a payment system in accordance with various aspects of this disclosure;

FIG. 2 shows a block diagram of a computing device relating to a payment system, in accordance with various aspects of this disclosure;

FIG. 3 shows a block diagram of a computing device relating to a payment system, in accordance with various aspects of this disclosure;

FIG. 4 shows a block diagram relating to operation of a payment system, in accordance with various aspects of this disclosure;

FIG. 5 is a flow chart illustrating an example of a method relating to a payment system, in accordance with various aspects of this disclosure;

FIG. 6 is a flow chart illustrating an example of a method relating to a payment system, in accordance with various aspects of this disclosure;

FIG. 7 is a flow chart illustrating an example of a method relating to a payment system, in accordance with various aspects of this disclosure;

FIG. 8 is a schematic representation of a login screen of a mobile application that operates systems and methods, in accordance with various aspects of this disclosure;

FIG. 9 is a schematic representation of a home screen of a mobile application that operates systems and methods, in accordance with various aspects of this disclosure;

FIG. 10 is a schematic representation of an operation screen of a mobile application that operates systems and methods, in accordance with various aspects of this disclosure;

FIG. 11 is a schematic representation of an operation screen of a mobile application that operates systems and methods, in accordance with various aspects of this disclosure;

FIG. 12 is a schematic representation of an operation screen of a mobile application that operates systems and methods, in accordance with various aspects of this disclosure;

FIG. 13 is a schematic representation of an operation screen of a mobile application that operates systems and methods, in accordance with various aspects of this disclosure;

FIG. 14 is a schematic representation of an operation screen of a mobile application that operates systems and methods, in accordance with various aspects of this disclosure;

FIG. 15 is a block diagram of a computer system suitable for implementing the present systems and methods of FIGS. 1-14.

### DETAILED DESCRIPTION

The present disclosure is directed to systems and methods that facilitate payments between parties; for example, payments in exchange for goods or services rendered. The parties involved may be referred to as the payee (e.g., the party that receives payment in exchange for goods or services) and the payor (e.g., the party that provides the payments, presumably in exchange for the goods and services). The payee and payor may include representatives of those entities that provide the goods and services and/or receive the goods and services.

In one scenario, the payor is a shipping company or broker for shipping goods, and the payee is a carrier that transports goods for the benefit of the shipper/broker. Within the shipping industry, the median size for a carrier company is one truck, which means the majority of carriers are individuals who own their own truck and contract with shipping/brokers to haul goods. The average size for carrier companies is about nine trucks, which means the industry is dominated by individuals and small companies. Individuals and small companies notoriously operate on relatively small budgets that require relatively quick payment in order to maintain necessary cash flow to sustain their businesses. Significant delays in receiving payment from the shipper/broker can be detrimental to such individuals and small companies. It is not uncommon in the trucking industry for such individuals and small companies to demand payment from the shipper/broker by a specific date, which is required in many scenarios because there is no understanding of when the payment would otherwise be received. Additionally, a number of resources are required in order to process payment to the carrier regardless of when the payment is made, which is a disincentive for the payor to process a payment. For example, an employee is usually required to receive the demand for payment from the carrier, the payment must be approved by an accounting department, management, etc., and the payment is routed through an accounts payable department to process the payment and transfer the funds to the carrier. Generally, the payment process is labor intensive and inefficient.

The systems and methods for payment disclosed herein provide improved efficiency in processing payment. The systems and methods disclosed herein may provide for improved clarity regarding when the payor will be making the payment. Further, the systems and methods disclosed herein may provide an option for the payee to adjust the terms of payment (e.g., the date for payment and the amount of the payment). For example, the payee may choose to be paid sooner than a date set by the payor to make the full payment by discounting the cost of their goods or services. The payor may be more willing to make a payment sooner if the payment amount is reduced. In this way, the payor and payee can both benefit by participating in the modification of payment terms in that the payee possibly gets paid sooner and the payor may actually pay less the goods or services provided by the payee. The payee may be provided with a “pay me now” option in which payment can be made immediately at a predetermined discounted and/or prorated price. Other payment options may be available in which the amount to be paid to the payee is reduced according to a discounting schedule or table (e.g., a discounting table, prorating schedule, or the like) in which a lesser amount is paid to the payee the closer the payment date is chosen to be relative to the original date set for payment by the payor.

The payor may establish the terms of the discounting schedule or table, including the terms (e.g., discount percentage) for a “pay me now” option. The discounting schedule or table may have a linear rate of change, such as a fixed percentage discount in the payment amount for each time period (e.g., day, week or month). In another embodiment, the discounting schedule or table may have an escalating change in discount percentage for each time period. In further embodiments, the discounting schedule or table is predetermined for a particular first party or second party, a specific industry, a type of good or service rendered, or as agreed upon in advance between the first and second parties.

In other embodiments, the payee may suggest or offer a certain discount percentage or amount associated with an earlier payment date. The systems and methods disclosed herein may facilitate a bidding system wherein the payor or the payee may bid or offer certain discount percentages or amount in association with certain payment dates. The parties may negotiate back and forth electronically with counter bids/offers until the payment terms are agreed upon by both parties.

One of the many advantages of the systems and methods disclosed herein is the cash savings possible for payees (e.g., brokers). For example, the systems and methods disclosed herein may provide brokers a chance to elect a pay me now option for a certain number of payors (e.g., carriers). The broker can choose any desired pay me know percentage for each carrier. For example, the broker may choose a pay me now percentage of 2% for carrier 1. If carrier 1 chooses that pay me know option, the carrier will receive a payment from the broker that is the original amount minus the 2%, which provides a 2% savings for the broker. The broker may select a different pay me know percentage of 3% for carrier 2, which would result in a 3% cash savings for the broker if carrier 2 accepts the pay me now option. In this way, the broker has significant flexibility about how much savings are possible for each payment transaction, and the payor can decide whether an early payment is worth the discounted amount the broker is willing to pay at a given time. Furthermore, the broker may adjust the discount amount for various pay me now payment dates for a given payor.

Another advantage of the systems and methods disclosed herein is the option of conducting various activities from a remote location, such as via an internet web page or a mobile application. This function may be particularly beneficial for payors (e.g., carriers) that are typically at remote locations as part of their carrier business activities.

The following description provides examples and is not limiting of the scope, applicability, and/or examples set forth in the claims. Changes may be made in the function and/or arrangement of elements discussed without departing from the scope of the disclosure. Various examples may omit, substitute, and/or add various procedures and/or components as appropriate. For instance, the methods described may be performed in an order different from that described, and/or various steps may be added, omitted, and/or combined. Also, features described with respect to some examples may be combined in other examples.

Certain embodiments of the payment system and methods are described with reference to various methods, apparatuses, systems, and computer programs that can be implemented by computer program instructions. These computer program instructions can be provided to a processor of a computing device, such as a general purpose computer, special purpose computer, mobile computing device, or other programmable data processing apparatus to produce a particular machine, such that the instructions, which execute via the processor of the computing device, implement the acts specified herein to transform data from a first state to a second state, and transmit data from one computing device to another computing device. For example, the processor may execute instructions directed to calculating payments and payment schedules, and facilitating the electronic transfer of payments over a wireless communication.

These computer program instructions can be stored in a computer-readable memory that can direct a computing device or other programmable data processing apparatus to operate in a particular manner, such that the instructions stored in the computer-readable memory produce an article of manufacture including instructions for implementing the acts specified herein. The computer program instructions may also be loaded onto a computing device or other programmable data processing apparatus to cause a series of operational steps to be performed on the computing device or other programmable apparatus to produce a computer-implemented process such that the instructions which execute on the computer or other programmable apparatus provide steps for implementing the acts specified herein.

The programming of the programmable apparatus creates a new machine, creating a special purpose computer once it is programmed that performs particular functions pursuant to instructions from program software. The payment system can be described in terms of a dedicated circuit or a process that emulates that circuit. The software processes of the payment system are, at least in part, interchangeable with a hardware circuit. This new machine can thus be implemented as a complex array of hardware circuits, programming that facilitates the unique functions of the payment system, or both.

The various illustrative logical blocks, modules, and algorithm steps described in connection with the embodiments disclosed herein can be implemented as electronic hardware, computer software, or combinations of both. To illustrate this interchangeability of hardware and software, various illustrative components, blocks, modules, and steps have sometimes been described generally in terms of their functionality. Whether such functionality is implemented as hardware or software depends upon the particular application and design constraints imposed on the overall system. The described functionality can be implemented in varying ways for each particular application and function, but such implementation decisions should not be interpreted as causing a departure from the scope of the disclosure.

The various illustrative logical blocks and modules described in connection with the embodiments disclosed herein can be implemented or performed with a general purpose processor, a specific purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices such as, for example, a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in random access memory (RAM), flash memory, read-only memory (ROM), Electrically Erasable Programmable Read-Only memory (EEPROM), Erasable Programmable Read-Only memory (EPROM), memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a computer terminal. In the alternative, the processor and the storage medium can reside as discrete components in a computer terminal.

Depending on the embodiment, certain acts, events, or functions of any of the methods described herein can be performed in a different sequence, can be added, merged, or left out altogether (e.g., not all described acts or events are necessary for the practice of the method), and otherwise mixed and matched as desired. Moreover, in certain embodiments, acts or events can be performed concurrently such as, for example, through multi-threaded processing, interrupt processing, or multiple processors or processor cores, rather than sequentially. Moreover, in certain embodiments, acts or events can be performed on alternate tiers or on alternate components within the architecture.

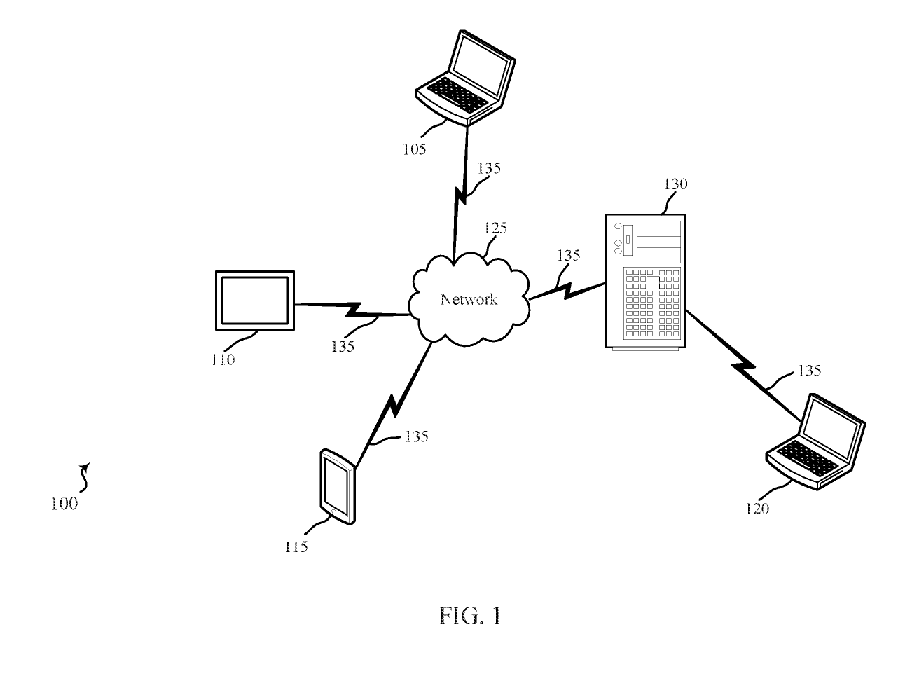

FIG. 1 is an example of a payment system 100 in accordance with various aspects of the disclosure. In some embodiments, the payment system 100 may include one or more computing device 105, 110, 115, 120, a network 125, and a server 130. The computing devices 105, 110, 115, 120 may be located locally or remotely relative to each other and the server 130. The network 125 may communicate via wired or wireless communication links 135. In alternate embodiments, the network 125 may be integrated with any one of the computing devices 105, 110, 115, 120 or server 130, such that separate components are not required.

Computing devices 105, 110, 115, 120 may be custom computing entities configured to interact with each other via network 125, and in some embodiments, via server 130. In other embodiments, computing devices 105, 110, 115, 120 may be general purpose computing entities such as a personal computing device, for example, a desktop computer, a laptop computer, a netbook, a tablet personal computer (PC), a control panel, an indicator panel, a multi-site dashboard, an iPod®, an iPad®, a smart phone, a mobile phone, a personal digital assistant (PDA), and/or any other suitable device operable to send and receive signals, store and retrieve data, and/or execute modules. The computing devices 105, 110, 115, 120 may be operated by or be under the control of the parties involved in a payment transaction or certain aspects of a payment transaction. For example, the computing devices 105, 110 may be a mobile computing device under the control of a payee (e.g., a carrier) who operates from a carrier vehicle (e.g., a semi-truck), and one or more of the computing devices 115, 120 may be under the control of a payor (e.g., a shipper/broker). In some embodiments, the system 100 includes a single one of the computing devices 105, 110, 115, 120 for the payor, a single one of the computing devices 105, 110, 115, 120 for the payee, the server 130 which stores data related to operation of system 100, and the network 1125 which facilitates communications between the components of system 100.

The computing devices 105, 110, 115, 120 may include memory, a processor, an output, a data input and a communication module. The processor may be a general purpose processor, a FPGA, an ASIC, a DSP and/or the like, as described above. The processor may be configured to retrieve data from and/or write data to the memory. The memory may be, for example, RAM, a memory buffer, a hard drive, a database, EPROM, EEPROM, ROM, a flash memory, a hard disk, a floppy disk, cloud storage, and/or so forth. In some embodiments, the computing devices 105, 110, 115, 120 may include one or more hardware-based modules (e.g., DSP, FPGA, ASIC) and/or software-based modules (e.g., a module of computer code stored at the memory and executed at the processor, a set of processor-readable instructions that may be stored at the memory and executed at the processor) associated with executing an application.

The processor of the computing devices 105, 110, 115, 120 may be operable to control operation of the output of the computing devices 105, 110, 115, 120. The output may be a television, a liquid crystal display (LCD) monitor, a cathode ray tube (CRT) monitor, speaker, tactile output device, a plasma display, a holographic output, and/or the like. In some embodiments, the output may be an integral component of the computing devices 105, 110, 115, 120. Similarly stated, the output may be directly coupled to the processor. For example, the output may be the integral display of a tablet and/or smart phone. In some embodiments, an output module may include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector operable to couple the computing devices 105, 110, 115, 120 to the output.

Any one of the computing devices 105, 110, 115, 120 may be a computing entity operable to enable a remote user to communicate with any component of payment system 100. The computing devices 105, 110, 115, 120 may be functionally and/or structurally similar to any other of the computing devices 115, 120 and may be operable to receive data streams from and/or send signals via the network 125. The network 125 may be the Internet, an intranet, a personal area network, a local area network (LAN), a wide area network (WAN), a virtual network, a telecommunications network implemented as a wired network and/or wireless network, etc. The computing devices 105, 110, 115, 120 may receive and/or send signals over the network 125 via communication links 135 and server 130.

Where computing device 105, 110, 115, 120 is a smart phone or tablet computer, the smart phone or tablet computer may have a dedicated application directed to, for example, receive payment-related data, calculate payment options, receive payment selections, and receive confirmation of selected payment options. The computing devices 105, 110, 115, 120 may process the data as part of facilitating a transaction. Data transmission may occur via, for example, frequencies appropriate for a personal area network (such as BLUETOOTH® or IR communications) or local or wide area network frequencies such as radio frequencies specified by the IEEE 802.15.4 standard.

The server 130 may perform additional processing on signals received from the computing devices 105, 110, 115, 120, or may simply forward the received information to the computing devices 105, 110, 115, 120. Server 130 may be a computing device operable to receive data streams (e.g., from computing devices 105, 110, 115, 120), store and/or process data, and/or transmit data and/or data summaries (e.g., to one of computing devices 105, 110, 115, 120). For example, server 130 may receive a stream of payment-related data from any one of the computing devices 105, 110, 115, 120. In some embodiments, server 130 may “pull” the data streams, e.g., by querying one or more of the computing devices 105, 110, 115, 120. In some embodiments, the data streams may be “pushed” from the computing devices 105, 110, 115, 120 to the server 130. For example, the computing devices 105, 110, 115, 120 may be configured to transmit data as it is generated by or entered into that device. In some instances, the computing devices 105, 110, 115, 120 may periodically transmit data (e.g., as a block of data or as one or more data points).

The server 130 may include a database (e.g., in memory) containing payment-related data received from the local computing devices 115, 120. Additionally, as described in further detail herein, software (e.g., stored in memory) may be executed on a processor of the server 130. Such software (executed on the processor) may be operable to cause the server 130 to monitor, process, summarize, present, and/or send a signal associated with resource usage data.

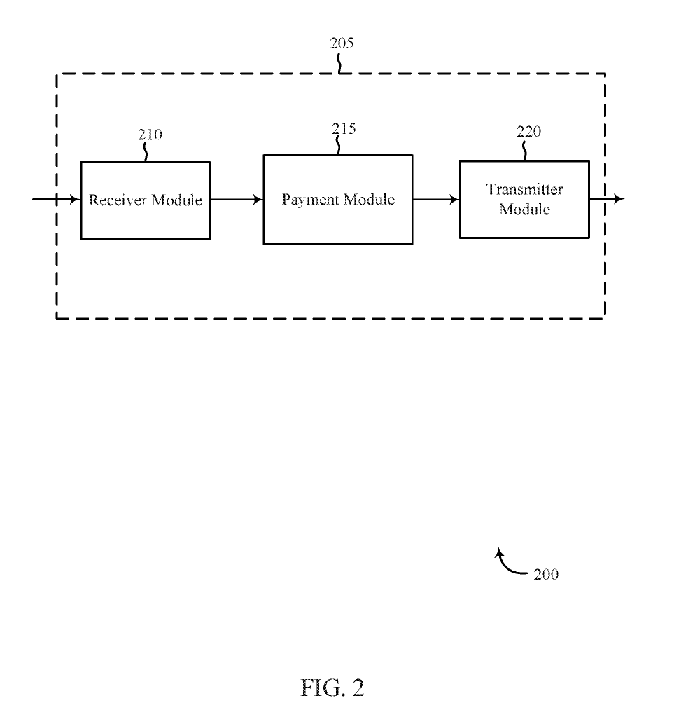

FIG. 2 shows a block diagram 200 of a computing device 205 for use in electronic communication, in accordance with various aspects of this disclosure. The computing device 205 may be an example of one or more aspects of the computing devices 105, 110, 115, 120 and/or server 130 described with reference to FIG. 1. The computing device 205 may include a receiver module 210, a payment module 215, and/or a transmitter module 220. The computing device 205 may also be or include a processor. Each of these modules may be in communication with each other-directly and/or indirectly.

The components of the computing device 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 210 may receive information such as packets, user data, and/or control information associated with various information channels (e.g., control channels, data channels, etc.). The receiver module 210 may be configured to receive communications from various other sources such as one or more of the computing devices 105, 110, 115, 120 described with reference to FIG. 1. Information may be passed on to the payment module 215, and to other components of the computing device 205.

The payment module 215 may receive data from a variety of sources via receiver module 210. The data may relate to one or more payments associated with goods or services that have or will be provided. Payment module 215 may operate to generate data in the form, for example, a set or pre-determined payment amount, a set or pre-determined payment date, various payment options from which a payee may select, calculated data based on a discounting schedule or table related to various payment options, notices, alarms, and the like.

The data generated by payment module 215 may be transmitted via transmitter module 220 to any one of variety of destinations including, for example, a computing device operated by or under control of a payor or payee involved in a payment transaction, or a network that is accessible by the computing devices under the control of the payee and/or payor.

In one example, the payment module 215 receives a payment amount and set payment date related to goods or services provided by a payee. The payment module may transmit (or otherwise make available) the payment information provided by the payor to the payee. The payment module may post, or publish, the payment details to a network such as the Internet. The payee may access the posted or published information via, for example, any available connection to the network (e.g., Internet), such as via a mobile computing device, a desktop computer, a tablet computer, or the like. In one example, a payee may use a computing device that operates an application that accesses the posted payment information made available by payment module 215.

The payment module 215 may operate to determine alternative payment options based on the payment amount and set payment date provided by the payor. For example, the payment module 215 may generate a payment schedule that includes reduced payment amounts for dates in advance of the set payment date. These payment options may also be posted by the payment module 215 to a network via, for example, transmitter module 220.

The payment module 215 may receive a selected payment amount and associated payment date (or a selected payment date with associated payment amount) from the payee. The payment module 215 may generate data such as an inquiry or notice for the payor to confirm and/or accept the selected payment date and payment amount from the payee. The payment module 215 may receive the confirmation from the payor related to the selected payment date and payment amount. The payment module 215 may operate to facilitate the payment of funds from the payor to the payee in response to the agreed upon terms by both parties. In one example, facilitating the payment of funds may include, but is not limited to, creating an indication of payment in digital form, transferring electronic payments to a financial institution by way of a wireless communication, querying a financial institution regarding availability of funds, making available electronic funds for transfer, and the like.

In at least some embodiments, the payment module 215 may store or access stored preferences and instructions related to a payment transaction between a payee and a payor if certain conditions are met. For example, the payor may provide instructions that are stored and made available to payment module 215 that the payor will accept any reduced payment amount selected by the payee. With these pre-entered instructions, the payment transaction may be able to proceed automatically without further interaction from the payor once the payor has provided the set payment amount and set payment date used by the payment module 215 to calculate the various payment options that the payee may select among. Similarly, the payee may, for example, provide instructions to always select the earliest payment option regardless of the reduced payment amount associated with that earliest payment date. In at least some embodiments, the earliest payment option may be a “pay me now” option that provides immediate payment such as same day payment from the payor. In another example, the payee may establish instructions to automatically accept payment within a certain number of days from when the goods or services are provided, regardless of the amount of the discount to the payment. In other embodiments, the instructions may be generated and/or calculated by way of computer learning methods and algorithms. Using computer learning methods, the instructions may be generated based on a history of payments, consideration of interest rates, availability of funds, consideration of credit scores, and other various data to automatically set up rules and options over time. Computer, or machine, learning methods and algorithms may include, but are not limited to artificial intelligence programming, decision trees, neural networks, Bayesian networks, associated rule learning, inductive logic, and clustering.

The transmitter module 220 may transmit the one or more signals received from other components of the computing device 205. The transmitter module 220 may transmit payment-related data such as payment options, payment instructions, and confirmation of payment terms and conditions. In some examples, the transmitter module 220 may be collocated with the receiver module 210 in a transceiver module.

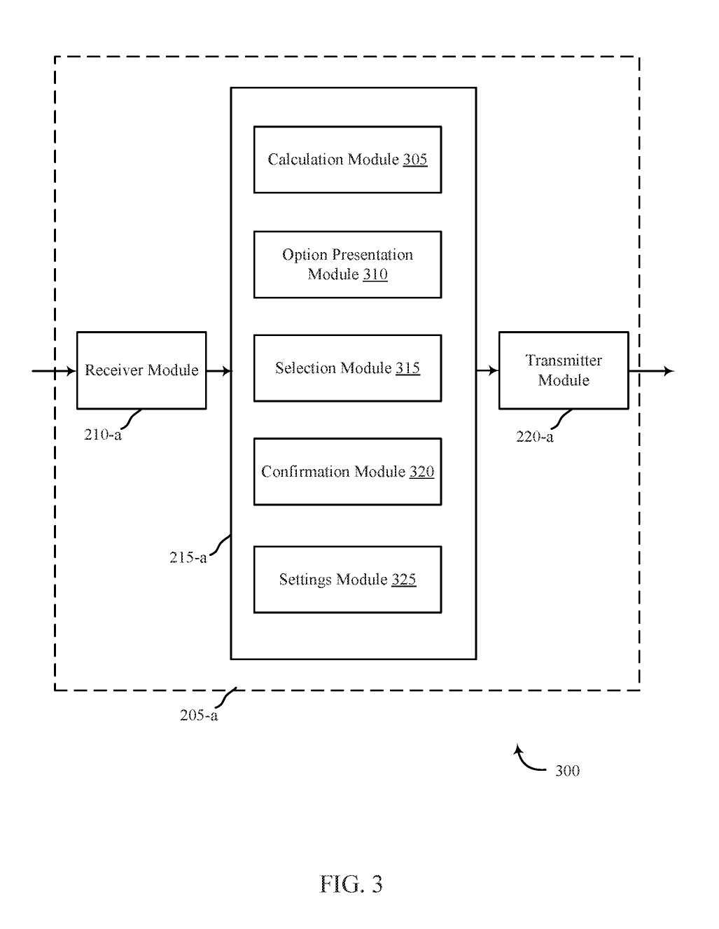

FIG. 3 shows a block diagram 300 of a computing device 205-a for use in wireless communication, in accordance with various examples. The computing device 205-a may be an example of one or more aspects of the computing devices 105, 110, 115, 120 described with reference to FIG. 1. It may also be an example of a computing device 205 described with reference to FIG. 2. The computing device 205-a may include a receiver module 210-a, a payment module 215-a, and/or a transmitter module 220-a, which may be examples of the corresponding modules of computing device 205. The computing device 205-a may also include a processor. Each of these components may be in communication with each other. The payment module 215-a may include a calculation module 305, an option presentation module 310, a selection module 315, a confirmation module 320, and/or a settings module 325. The receiver module 210-a and the transmitter module 220-a may perform the functions of the receiver module 210 and the transmitter module 220, of FIG. 2, respectively.

The calculation module 305 may operate to calculate additional payment options and payment dates in accordance with a discounting schedule or table. The discounting schedule or table may be associated with a particular payee, payor, industry, time of year, or any other of a variety of parameters or factors. The calculation module 305 may operate automatically in response to receiving information about a payment amount and set payment date received from the payor. For example, the calculation module 305 may use data physically input by a user, or received by a user over a wireless communication link, and/or the calculation module 305 may use computer learning methods and algorithms to calculate payment options based on the payee, the payor, the date, the amount, the goods and/or services, etc. The calculation module 305 may make further adjustments to the available options based on continuing calculations and additional data. In some embodiments, the payor may select among a variety of tables or schedules that the calculation module 305 will use to generate the additional payment options.

The option presentation module 310 may format, organize, or otherwise prepare for presentation the payment options generated by calculation module 305. Option presentation module 310 may utilize other information such as the set payment amount and set payment date provided by the payor and other details related to payment, selection of options and information that may be used by the payee to help select a desired payment amount and payment date. Option presentation module 310 may generate data that is used by other programs, applications, or the like to present the data to the payee and/or payor. In some embodiments, the option presentation module 310 may automatically format, organize, or otherwise prepare the payment options based on computer learning algorithms, such as payor and/or payee preferences, including historic selections, payments, and other data. Data may be presented to the payee and/or payor by way of a wireless communication link. Presentation may be prompted by a user, or may be automated based on computer learning algorithms.

Selection module 315 may receive selection data from a payee and/or payor related to various payment options and other information that is presented to a payee and/or payor. Selection module 315 may route selection data to other modules of payment module 215. In some embodiments, selection module 315 may receive selection data from another computing device such as a handheld mobile computing device carried by a payee. The handheld mobile computing device may be in communication with a network such as the Internet, and the selection module 315 may also communicate with the network to obtain the selection information over a wireless communication link.

Confirmation module 320 may operate to present an inquiry to the payor related to the selected payment option provided via the payee. Confirmation module 320 may present an inquiry as well as receive a confirmation response from the payor. Once the confirmation module 320 receives confirmation from the payor, either directly in response to the inquiry or based on a preset instruction or setting, the confirmation module 320 may direct further operation of payment module 215 to facilitate payment between the payor and payee. In some embodiments, the confirmation module 320 may, with or without direct user input, request or receive information from a financial institution to confirm the availability of funds and/or the possibility of payment.

Settings module 325 may store and/or access preset and/or real-time settings for payment module 215 and/or computing device 205 generally. For example, settings module 325 may store and/or access instructions from the payor related to the criteria by which the alternative payment options may be determined by calculation module 305. In another example, settings module 325 may store and/or access instructions provided by the payor related to automatically accepting certain of the available payment options that the payee may select among. Settings module 325 may also store and/or access instructions or settings associated with how funds are transferred between the payor and payee such as, for example, using stored information about bank accounts and pre-authorization to transfer funds if certain criteria are met.

While the various modules 305, 310, 315, 320, 325 are shown as part of a single payment module 215 of a computing device 205, other embodiments may include any or all of the modules shown in FIG. 3 as part of other payment modules 215 and/or other computing devices 205. Furthermore, the payment module 215-a may include additional or fewer of the modules shown in FIG. 3, and/or at least some of the functionality of any of the modules 305, 310, 315, 320, 325 may be consolidated and/or modified as needed for any given application.

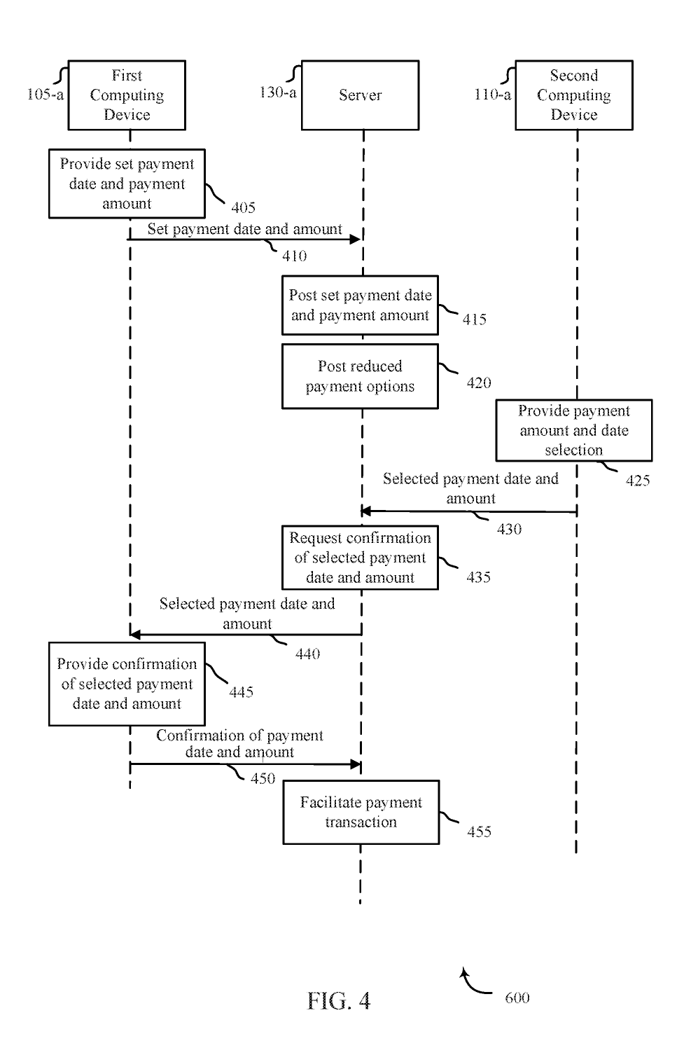

FIG. 4 illustrates an example method of payment using a swim diagram 400. The diagram 400 includes a first computing device 105-a, a server 130-a, and a second computing device 110-a, which may be representative of any device, application operable by a device, or system that provides the functions illustrated by diagram 400. For example, the server 130-a may be replaced with any computing device such as one of computing devices 105, 110, 115, 120, 205 described above.

According to diagram 400, first computing device 105-a provides a predetermined or set payment date and payment amount at block 405. The payment date and payment amount 410 are delivered to server 130-a. Server 130-a posts the set payment date and payment amount at block 415 and posts reduced payment options at block 420. Posting information according to blocks 415 and 420 may include making the payment option information available via a network (e.g., network 125) for access and/or viewing. As described above, the reduced payment options may include a plurality of reduced payment amounts corresponding to days that are closer to (and potentially including) a present date. The reduced payment options may be determined by one or more computing devices such as server 130-a based on, for example, a pre-set schedule or table that includes percentage reduction in the payment amount associated with specific days in advance of the set payment date. In other embodiments, the reduced payment options may be calculated in real-time (e.g., by computer learning methods and/or other algorithms), based on a plurality of considerations such as, but not limited to, historical payment data, information related to the payor and/or payee, a history of business between the payor and/or payee, current credit scores, current interest rates, available funds, the types of goods and/or service, the time of year, knowledge of future business, etc.

The second computing device 110-a may access the posted set payment dates and payment amounts, post the reduced payment options and provide a selection of a payment amount and date at block 425. The selected payment date and amount 430 may be transmitted to server 130-a. Server 130-a may request confirmation of the selected payment date and amount at block 435. The selected payment date and amount 440 may be sent to the first computing device 105-a. The first computing device 105-a may provide confirmation of the selected payment date and amount at block 445. The confirmation of payment date and amount 450 may be sent back to server 130-a. Server 130-a may facilitate a payment transaction at block 455. The payment transaction may include transfer of funds from the entity controlling the first computing device 105-a to the entity controlling the second computing device 110-a. In at least one arrangement, the first computing device 105-a is associated with a payor and the second computing device 110-a is associated with a payee. In one particular embodiment, the payor is a shipper/broker and the payee is a carrier in the trucking industry.

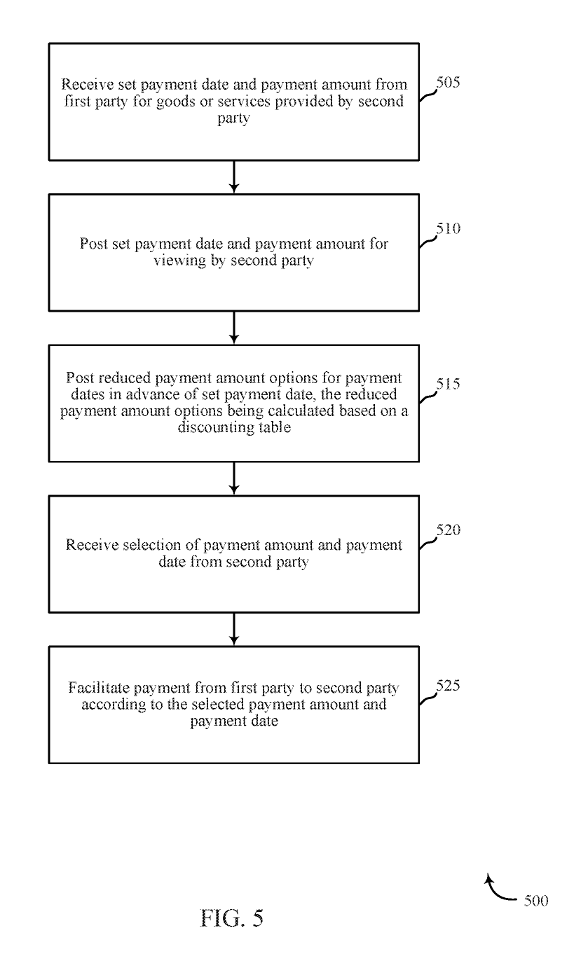

The swim diagram 400 may be modified in a number of ways to include more or fewer steps and/or details as part of a payment method and/or operation of a payment system. For example, swim diagram 400 may be modified to accomplish only the steps set forth in the methods 500, 600, 700, described below with references to FIGS. 5-7.

In other embodiments, the diagram 400 may be modified to remove the server 130-a. In such an embodiment, one or the other of the first computing device 105-a and the second computing device 110-a acts as a hub or central computing device that receives input directly from one or the other of the payor and payee (e.g., via a user interface), and receives data and/or communications from the other of the payor and payee via a different computing device and/or network providing communication between the two computing devices.

FIG. 5 is a flow diagram illustrating an example of a payment method 500 for facilitating payment between first and second parties. The payment method 500 may be applicable in a variety of scenarios where one party owes payment to the other (e.g., for goods or services provided). The payment method 500 provides options for the payee to modify the date for receiving payment. Typically, an earlier payment date has a greater discount applied to the amount of the payment.

For clarity, the method 500 is described below with reference to aspects of one or more of the computing devices 105, 110, 115, 120, 205 described with reference to FIGS. 1-4, and/or aspects of one or more of the payment modules 215 described with reference to FIGS. 2 and 3. In some examples, a payment module 215 may execute one or more sets of codes to control the functional elements of the computing devices 105, 110, 115, 120, 205 to perform the functions described herein. Additionally or alternatively, the computing devices 105, 110, 115, 120, 205 and payment modules 215 may perform one or more of the functions described below using special-purpose hardware.

At block 505, the method 500 may include receiving set payment dates and payment amounts from a first party for goods or services provided by a second party. At block 510, the method 500 includes posting the set payment date and payment amount for viewing by the second party. Block 515 includes posting the reduced payment amount options for payment dates in advance of the set payment date, wherein the reduced payment amount options are calculated based on a discounting table, or the like. Block 520 includes receiving selection of payment amount and payment date from the second party. Block 525 includes facilitating payment from the first party to the second party according to the selected payment amounts and payment dates.

The method 500 may also include delivering a selected payment amount and payment date to the first party, and receiving confirmation from the first party that the selected payment amount and payment date is accepted prior to facilitating payment. Delivery, receipt, and facilitation of the payment amount and payment date may be effectuated by decisions determined through computer learning algorithms, and may be automatically effected without additional user input. The method 500 may also provide that the posted date and payment amount and posted reduced payment amounts are available via a mobile computing device. The discounting table may include decreasing percentages of the set payment amount. The discounting table may include a payment option for a date on which the set payment date and payment amount are posted. The first party may be a shipping broker and the second party may be a shipping carrier.

The method 500 may provide for selected payment terms by a payee and confirmation of a selected terms by a payor, which may result in a payment transaction that is beneficial to both the payor and payee. It should be noted that the method 500 is just one implementation and that the operations of the method 500 may be rearranged or otherwise modified such that other implementations are possible. In some embodiments, the elements of method 500 may be communicated in part by a wireless communication link.

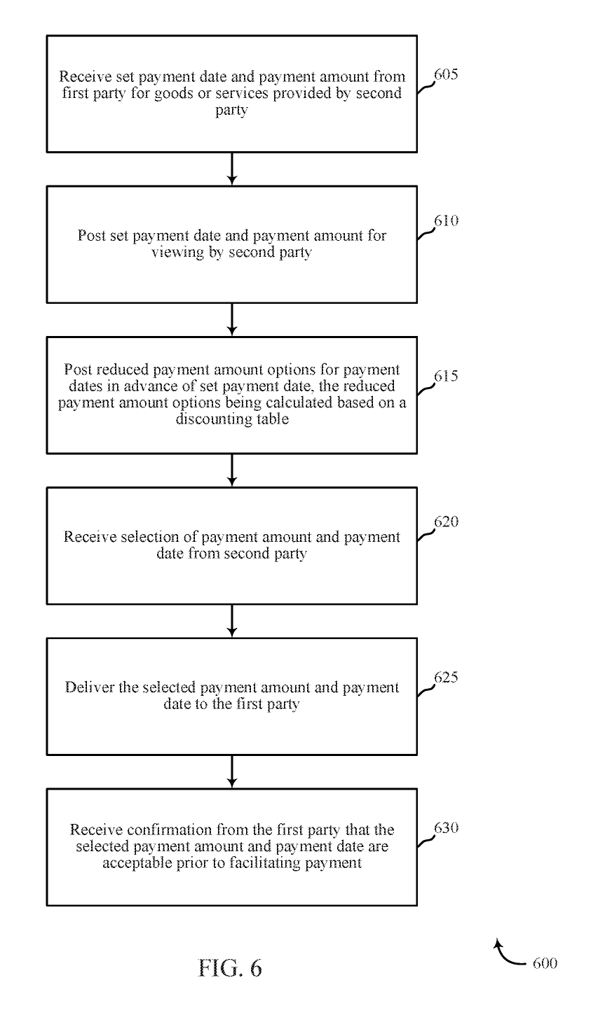

FIG. 6 is a flow chart illustrating an example of a payment method 600 for facilitating payment between first and second parties. The payment method 600 may be applicable in a variety of scenarios where one party owes payment to the other (e.g., for goods or services provided). The payment method 600 provides options for the payee to modify the date at which they receive payment. Typically, an earlier payment date has a greater discount applied to the amount of the payment.

The method 600 is described below with reference to aspects of one or more of the computing devices 105, 110, 115, 120, 205 described with reference to FIGS. 1-4, and/or aspects of one or more of the payment modules 215 described with reference to FIGS. 2 and 3. In some examples, a payment module 215 may execute one or more sets of codes to control the functional elements of the computing devices 105, 110, 115, 120, 205 to perform the functions described herein. Additionally or alternatively, the computing devices 105, 110, 115, 120, 205 and payment modules 215 may perform one or more of the functions described below using special-purpose hardware.

At block 605, the method 600 includes receiving a set payment date and payment amount from a first party for goods or services provided by a second party. Block 610 includes posting the set payment date and payment amount for viewing by the second party. Block 615 includes posting reduced payment options for payment dates in advance of the set payment date, wherein the reduced payment amount options are calculated based on a discounting table. Block 620 includes receiving a selection of payment amount and payment date from the second party. Block 625 includes delivering the selected payment amount and payment date to the first party. Block 630 includes receiving confirmation from the first party that the selected payment amount and payment date are accepted prior to facilitating payment. The method 600 may also include facilitating payment from the first party to the second party according to the selected payment amount and payment date.

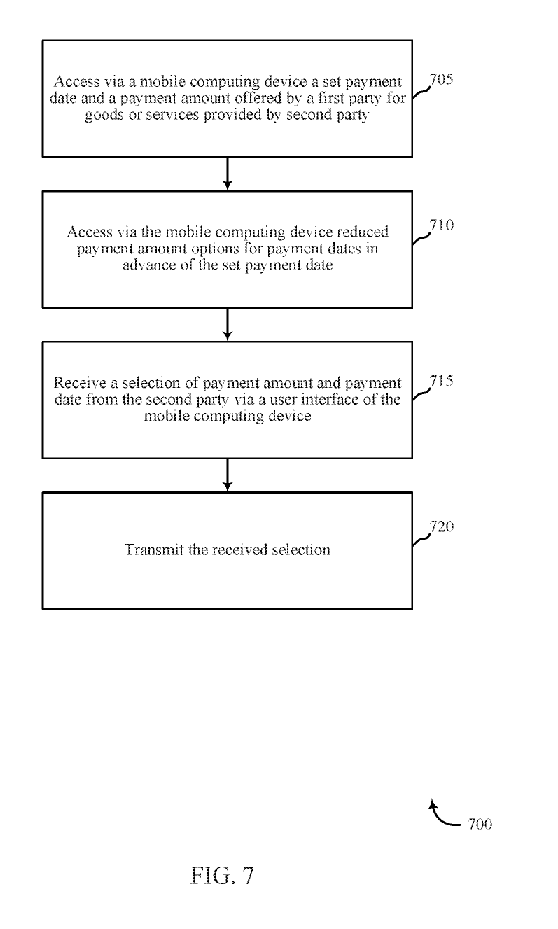

FIG. 7 is a flow chart illustrating an example of a payment method 700 for facilitating payment between first and second parties. The payment method 700 may be applicable in a variety of scenarios where one party owes payment to the other (e.g., for goods or services provided). The payment method 700 provides options for the payee to modify the date at which they receive payment. Typically, an earlier payment date has a greater discount applied to the amount of the payment.

The method 700 is described below with reference to aspects of one or more of the computing devices 105, 110, 115, 120, 205 described with reference to FIGS. 1-4, and/or aspects of one or more of the payment modules 215 described with reference to FIGS. 2 and 3. In some examples, a payment module 215 may execute one or more sets of codes to control the functional elements of the computing devices 105, 110, 115, 120, 205 to perform the functions described herein. Additionally or alternatively, the computing devices 105, 110, 115, 120, 205 and payment modules 215 may perform one or more of the functions described below using special-purpose hardware.

At block 705, the method 700 includes accessing via a mobile computing device, a set payment date and payment amount offered by a first party for goods or services provided by a second party. Block 710 includes accessing via a mobile computing device reduced payment amount options for payment dates in advance of the set payment date. Block 715 includes receiving a selection of payment amount and payment date from the second party via an user interface of the mobile computing device. Block 720 includes transmitting the received selection.

Method 700 may also include delivering the selected payment amounts and payment dates to the first party, and receiving confirmation from the first party that the selected payment amount and payment date is acceptable prior to facilitating payment. The reduced payment amount options may be calculated based on a discounting table. The method 700 may include receiving confirmation of payment from the first party to the second party according to the selection. The method 700 may be performed using a standard or stationary computing device (e.g., a desktop computer) in place of a mobile computing device.

In some examples, aspects from two or more of the methods 500, 600, 700 may be combined and/or separated. It should be noted that the methods 500, 600, 700 are just example implementations, and that the operations of the methods 500, 600, 700 may be rearranged or otherwise modified such that other implementations are possible.

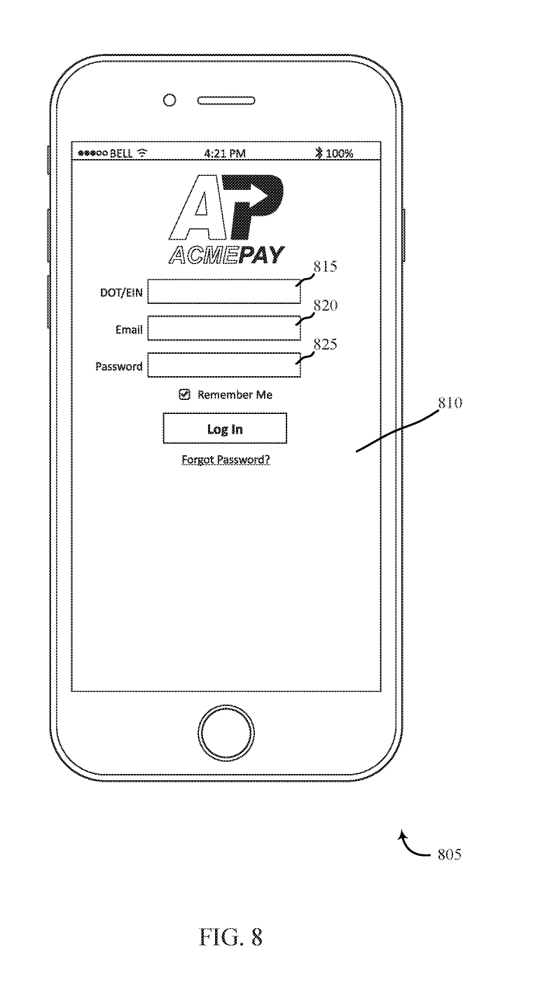

FIGS. 8-13 are examples of screenshots from a computing device 805 that operates according to certain aspects of the present disclosure. The computing device 805 includes a display screen 810. The display screen 810 may provide a graphical user interface for a software application operating on the computing device 805. The display screen 810 may include a touch screen or have touch screen capabilities. Computing device 805 may include other user input feature such as buttons, switches, microphones, speakers, cameras, sensors (including biometric sensors) and the like to provide communication capability with a user. The screenshots shown in FIGS. 8-13 may represent functionality of an application developed specifically for a payee according to the systems and methods disclosed herein, and particularly for a payee that is a carrier in the trucking industry.

FIG. 8 shows the display screen 810 at a log-in page that includes several live fields for entry of user information. For example, a field 815 may receive input regarding Department of Transportation (DOT) and/or employer identification (EIN) numbers. A field 820 may be used for entry of an email address, or other identifying information. Field 825 may provide for entry of a password. The log-in screen may have other features and functionality such as a “Remember Me” selection box to remember the data entered into any one of fields 815, 820, 825. The log-in screen of FIG. 8 may also include a log-in selection button and a link to access forgotten passwords. The log-in screen shown in FIG. 8 may include other information such as, for example, an indicator of a wireless service provider, an indicator of the wireless signal strength, an indicator of a wireless signal strengths, including Wi-Fi, Bluetooth, Near Field Communications (NFC), etc., a time of day and date, a battery strength indicator, and the like.

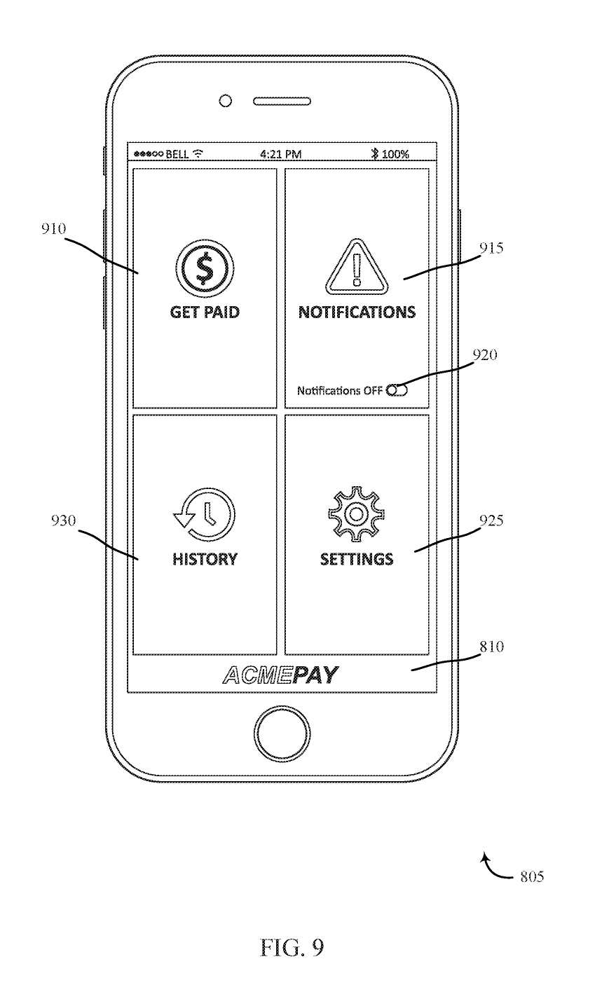

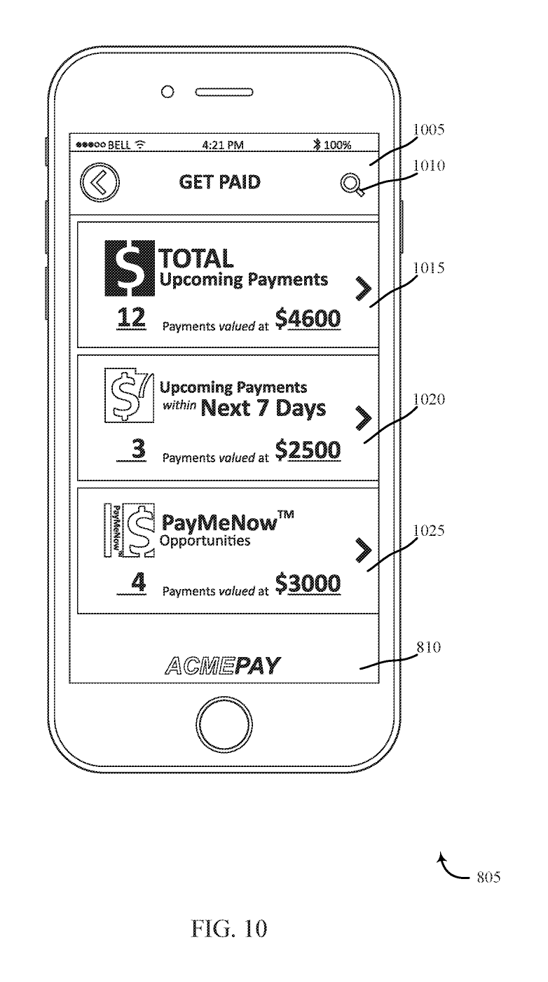

FIG. 9 shows an example screenshot of another page, such as a home page after logging in, for the application operating on computing device 805. The home page may include a plurality of selectable options shown on display screen 810. In some embodiments, any of the options may be selected by way of tactile input, audio commands, pre-determined user preferences, etc. For example, one selectable option may be a payment request option 901 (e.g., “Get Paid”). Another selectable option may be a notifications option 915. The notification option 915 (“Notifications”) may include an on/off selector 920 to control whether notifications are conveyed and/or displayed. Another selectable option may be a settings option 925 for setting or viewing settings and/or preferences (e.g., “Settings”). A further selectable option may be a history option 930 (e.g., “History”). Selecting any one of the options 910, 915, 925, 930 on screen 810 may activate another screen for viewing and user interaction. FIGS. 10 and 12-14 show other page options which may be accessed by a selection of options 910, 915, 925, 930.

FIG. 10 shows an example screenshot of the payment request option 910 (e.g., “Get Paid”) page on screen 810. The payment request option 910 may include a header 1005, where header 1005 may contain additional information and/or interactive options such as a search option 1010. The payment request option 910 page may show one or more summaries of the payments that are due to a payee. The example summaries 1015, 1020, 1025 may include a total number of payments due, a total value of the payments, and potentially a date for the payment to be made.

Each of the summaries 1015, 1020, 1025 may include different types of information such as the total number of upcoming payments within summary 1015, the upcoming payments due within a certain timeframe (e.g., seven days) shown within summary 1020, and the “Pay Me Now” options that are available in summary 1025. Selecting any one of these summaries 1015, 1020, 1025 may activate a new page of information listing the payments associated with that particular summary. In some examples, the number of payments for the total of upcoming payments and/or the value of upcoming payments may be equal, different, and/or may otherwise be determined by user preferences or other considerations.

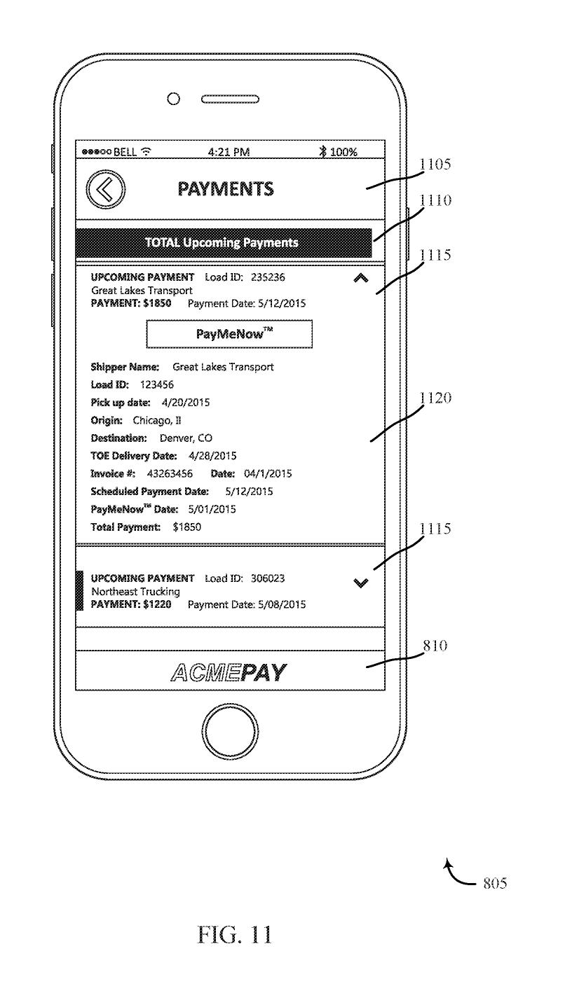

FIG. 11 shows an example screenshot of the upcoming payments option 1015 selected from the page shown in FIG. 10. FIG. 11 includes a header 1105 for the payments option, a subheader 1110 for the total upcoming payments, and a plurality of entries 1115. In one embodiment, selecting the down arrow for any one of the entries 1115 may result in an overlay window 1120 which details “Pay Me Now” options 1120 for the selected payment. The payee may review the “Pay Me Now” options and determine, for example, whether the payee wishes to receive payment at an earlier date for a reduced payment amount. In some embodiments, each of the entries 1115 (displayed under the overlay window 1120) may include other payment options in addition to, or in place of, a “Pay Me Now” option for immediate payment. The other options may provide reduced payment amounts for dates between the date associated with the “Pay Me Now” option and the predetermined payment date established by the payor for payment of the full amount due.

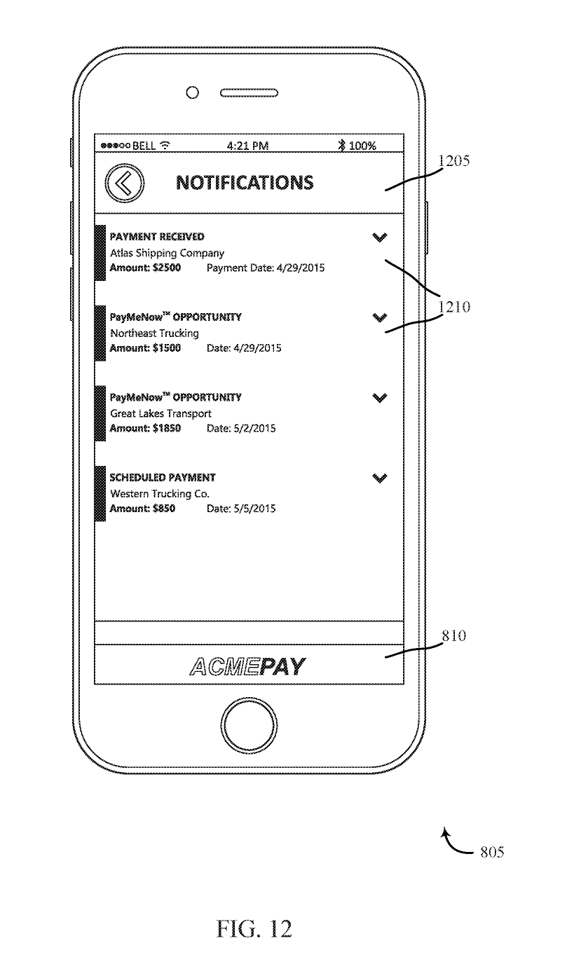

FIG. 12 shows an example screenshot of the notification option 915 page. FIG. 12 includes a header 1205 and a plurality of notifications 1210 for review by the payee. In some embodiments, any of the notifications 1210 may be selectable to provide the user with additional information. The notices 1210 show various entries such as payment received, “Pay Me Now” options, and schedule payment information.

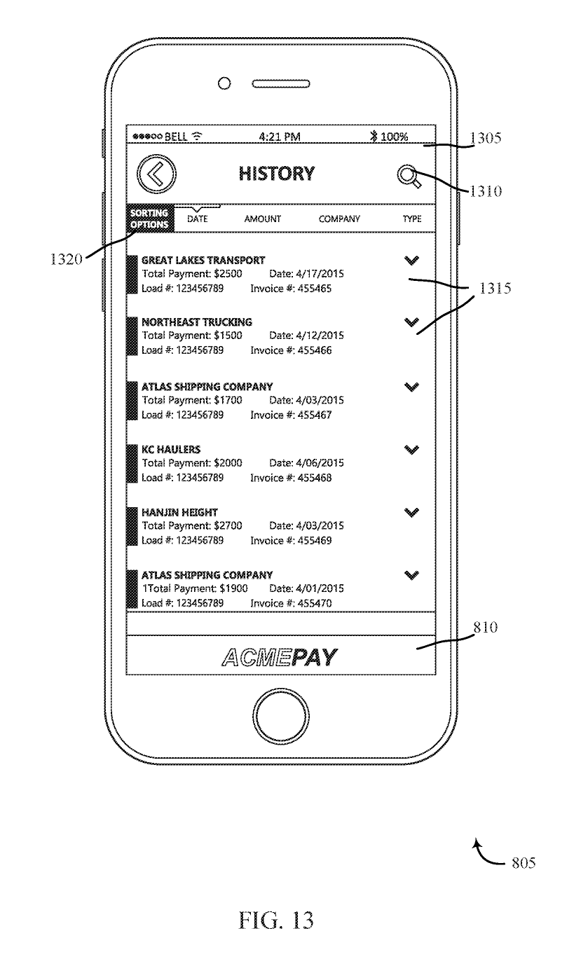

FIG. 13 shows an example screenshot of the history option 930 page. FIG. 13 may include a header 1305, where header 1305 may contain additional information and/or interactive options such as a search option 1310. FIG. 13 may include a subheader 1320 which may contain additional information and/or interactive options; for example, the subheader 1320 may contain selection options related to sorting options. A payee may search using criteria such as, but not limited to, payor information (e.g., shipper/broker name), invoice number, load number, total payment and payment date. The history page may include a plurality of entries 1315 showing some or all of the activity of the payee which, in the context of the trucking industry, may be a list of all of the carrier jobs completed by the payee. In some embodiments, a user may set preferences related to the entries 1315, such as by date, type, and/or amount, etc. Each of the entries 1315 may have a drop down option, or otherwise selectable option, associated therewith to provide further details related to a given activity.

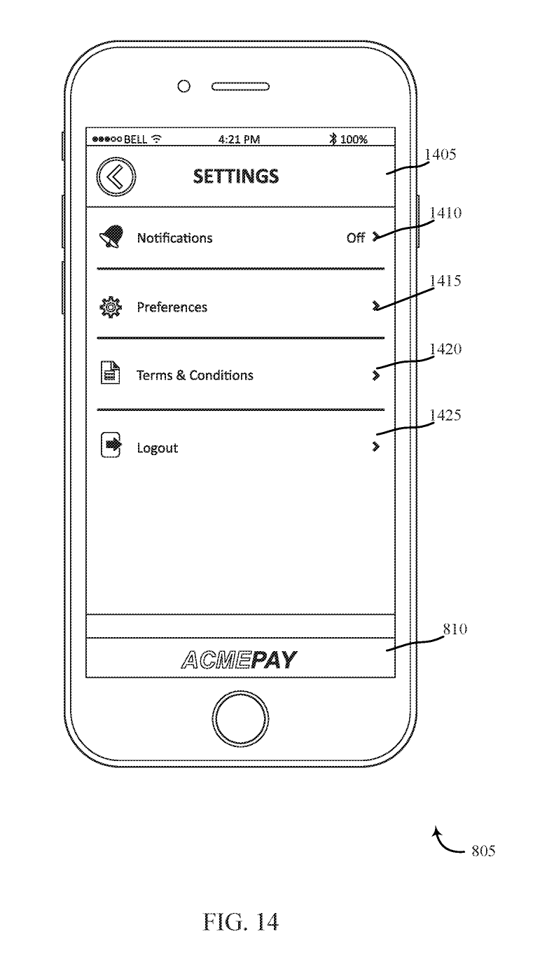

FIG. 14 shows an example screenshot of the settings option 935 page. FIG. 14 may include a header 1405 for the page and a plurality of setting example categories: a notifications category 1410, a preferences category 1415, a terms and conditions category 1420, and log-out option 1425. Many other categories and settings options may be presented on the settings page shown in FIG. 14. In one embodiment, the settings options 935 page may include an option for the payee to enter instructions related to payments for the different events listed in the history. For example, the instructions may include automatically accepting “Pay Me Now” options for any event in which the “Pay Me Now” amount is within a certain percentage of the total payment amount available at the set payment date. Another instruction may relate to certain actions to take place when the payment amount at the set payment date is within a certain dollar range, or if the set payment date is outside of a predetermined time window. In some embodiments, the instructions and/or actions (including input and output) may be determined without manual user input, and may be determined and presented as a result of computer learning and/or other algorithms. A variety of settings options may be available to further automate the process of approving certain payment options that may be available.

The information and functionality available through the application that is operating on computing device 805 shown in FIGS. 8-14 may be particularly suited for the payee, such as a carrier in the trucking industry. An application with similar features and functionality may be available in accordance with the principles disclosed herein for use by the payor, such as the shipper/broker in the trucking industry. The options available to the payor may have some similarities and some distinct differences from the features and functionality described with reference to FIGS. 8-14. A payor-specific application and/or computing device may focus on the payor having selectable options for the reduced payment percentage and associated days for a pay me now option or any other reduced payment option between the present date and a set final payment date and payment amount, the ability to confirm a selected payment option from the payee, the ability to pre-set instructions for various scenarios associated with the selected payment options from the payee, and the like. The application that operates on a computing device for the payor may be adapted for use on a mobile computing device. The applications operating on computing devices for both the payor and payee may communicate with each other via a network such as the Internet, as described herein.

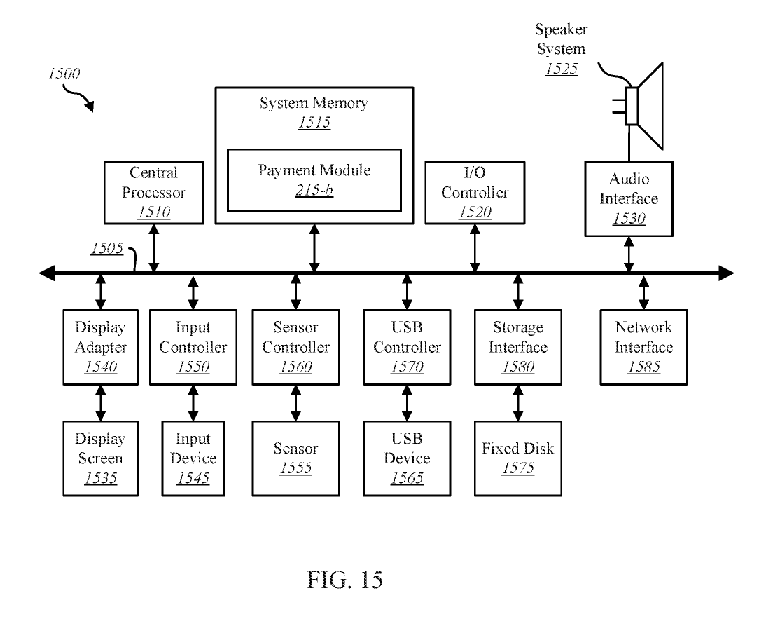

FIG. 15 depicts a block diagram of a controller 1500 suitable for implementing the present systems and methods. In one configuration, controller 1500 includes a bus 1505 which interconnects major subsystems of controller 1500, such as a central processor 1510, a system memory 1515 (typically RAM, but which may also include ROM, flash RAM, or the like), an input/output controller 1520, an external audio device, such as a speaker system 1525 via an audio output interface 1530, an external device, such as a display screen 1535 via display adapter 1540, an input device 1545 (e.g., remote control device interfaced with an input controller 1550), multiple USB devices 1565 (interfaced with a USB controller 1570), and a storage interface 1580. Also included are at least one sensor 1555 connected to bus 1505 through a sensor controller 1560 and a network interface 1585 (coupled directly to bus 1505).

Bus 1505 allows data communication between central processor 1510 and system memory 1515, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the payment module 215-b to implement the present systems and methods may be stored within the system memory 1515. Applications resident with controller 1500 are generally stored on and accessed via a non-transitory computer readable medium, such as a hard disk drive (e.g., fixed disk drive 1575) or other storage medium. Additionally, applications can be in the form of electronic signals modulated in accordance with the application and data communication technology when accessed via network interface 1585.

Storage interface 1580, as with the other storage interfaces of controller 1500, can connect to a standard computer readable medium for storage and/or retrieval of information, such as a fixed disk drive 1575. Fixed disk drive 1575 may be a part of controller 1500 or may be separate and accessed through other interface systems. Network interface 1585 may provide a direct connection to a remote server via a direct network link to the Internet via a POP (point of presence). Network interface 1585 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 1500 wirelessly via network interface 1585.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 15 need not be present to practice the present systems and methods. The devices and subsystems can be interconnected in different ways from that shown in FIG. 15. The aspect of some operations of a system such as that shown in FIG. 15 are readily known in the art and are not discussed in detail in this application. Code to implement the present disclosure can be stored in a non-transitory computer-readable medium such as one or more of system memory 1515 or fixed disk drive 1575. The operating system provided on controller 1500 may be iOS ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purposes of explanation, has been described with reference to specific embodiments; however, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims are to be construed as meaning “at least one of” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A method for payment, comprising:
receiving, from a first party, a predetermined payment date and a predetermined payment amount for goods or services provided by a second party;
publishing, by a processor, the predetermined payment date and predetermined amount for viewing by the second party;
calculating, by the processor, at least one reduced payment amount option for at least one pre-payment date, the pre-payment date in advance of the predetermined payment date, the at least one reduced payment amount option calculated based at least on a discounting table;
publishing, by the processor, the at least one reduced payment amount for viewing;
receiving, by the processor, a selection of one of the at least one reduced payment amount options from a second party, wherein the selection comprises a selected reduced payment amount and one of the at least one pre-payment date; and
facilitating payment from the first party to the second party according to the selected payment amount and payment date.

2. The method of claim 1, wherein calculating further comprises:
calculating at least one reduced payment amount option by a computer learning algorithm.

3. The method of claim 2, where calculating by the computer learning algorithm includes of at least one from the group comprising: decision trees, neural networks, Bayesian networks, associated rule learning, inductive logic, and clustering.

4. The method of claim 1, further comprising:
delivering, by a wireless communication, the selected reduced payment option to the first party; and
receiving, by the processor, confirmation from the first party that the selected payment amount and payment date is acceptable prior to facilitating payment.

5. The method of claim 1, wherein facilitating further comprises:
receiving electronic payment information associated with the selected payment amount.

6. The method of claim 5, wherein facilitating further comprises:
sending the received electronic payment information to a financial institution associated with the second party.

7. The method of claim 1, wherein the published predetermined payment date and predetermined payment amount and the at least one reduced payment amounts are available via a mobile computing device.

8. The method of claim 1, wherein the discounting table includes decreasing percentages of the set payment amount, based at least in part on the calculating.

9. The method of claim 1, wherein the discounting table includes a payment option for a date on which the predetermined payment date and predetermined payment amount are published.

10. The method of claim 1, further comprising:
receiving at least one discount percentage from the first party, the at least one discount percentage being used to establish the discounting table.

11. An apparatus for a payment system, comprising:
a processor;
memory in electronic communication with the processor; and
instructions stored in the memory, the instructions being executable by the processor to:
receive, from a first party, a predetermined payment date and a predetermined payment amount for goods or services provided by a second party;
publish, by a processor, the predetermined payment date and predetermined amount for viewing by the second party;
calculate, by the processor, at least one reduced payment amount option for at least one pre-payment date, the pre-payment date in advance of the predetermined payment date, the at least one reduced payment amount option calculated based at least on a discounting table;
publish, by the processor, the at least one reduced payment amount for viewing;
receive, by the processor, a selection of one of the at least one reduced payment amount options from a second party, wherein the selection comprises a selected reduced payment amount and one of the at least one pre-payment date; and
facilitate payment from the first party to the second party according to the selected payment amount and payment date.

12. The apparatus of claim 11, wherein when the processor calculates, the instructions are further executable by the processor to:
calculate at least one reduced payment amount option by a computer learning algorithm.

13. The apparatus of claim 12, wherein when the processor calculates, the instructions are further executable by the processor to calculate using at least one algorithm that includes of at least one from the group comprising: decision trees, neural networks, Bayesian networks, associated rule learning, inductive logic, and clustering.

14. The apparatus of claim 11, the instructions being further executable by the processor to:
deliver, by a wireless communication, the selected reduced payment option to the first party; and
receive, by the processor, confirmation from the first party that the selected payment amount and payment date is acceptable prior to facilitating payment.

15. The apparatus of claim 11, wherein when the processor facilitates, the instructions are further executable by the processor to:
receive electronic payment information associated with the selected payment amount.

16. The apparatus of claim 15, wherein when the processor facilitates, the instructions are further executable by the processor to:
send the received electronic payment information to a financial institution associated with the second party.

17. The apparatus of claim 11, wherein the discounting table includes decreasing percentages of the set payment amount, based at least in part on the calculating.

18. The apparatus of claim 11, wherein the discounting table includes a payment option for a date on which the predetermined payment date and predetermined payment amount are published.

19. The apparatus of claim 11, the instructions being further executable by the processor to:
receive at least one discount percentage from the first party, the at least one discount percentage being used to establish the discounting table.

20. A non-transitory computer readable medium storing code for a payment system, the code comprising instructions executable by a processor to:
receive, from a first party, a predetermined payment date and a predetermined payment amount for goods or services provided by a second party;
publish, by a processor, the predetermined payment date and predetermined amount for viewing by the second party;
calculate, by the processor, at least one reduced payment amount option for at least one pre-payment date, the pre-payment date in advance of the predetermined payment date, the at least one reduced payment amount option calculated based at least on a discounting table;
publish, by the processor, the at least one reduced payment amount for viewing;
receive, by the processor, a selection of one of the at least one reduced payment amount options from a second party, wherein the selection comprises a selected reduced payment amount and one of the at least one pre-payment date; and
facilitate payment from the first party to the second party according to the selected payment amount and payment date.
